(19) United States
(12) Patent Application Publication
(10) Pub. No.: US 2017/0155741 A1
(43) Pub. Date: Jun. 1, 2017

(54) SERVER, METHOD, AND SYSTEM FOR PROVIDING SERVICE DATA

(71) Applicants: LE HOLDINGS (BEIJING) CO., LTD., BEIJING (CN); LE SHI INTERNET INFORMATION & TECHNOLOGY CORP., BEIJING, Beijing (CN)

(72) Inventor: Lei QIAO, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/236,519

(22) Filed: Aug. 15, 2016

Related U.S. Application Data
(63) Continuation of application No. PCT/CN2016/089515, filed on Jul. 10, 2016.

(30) Foreign Application Priority Data
Dec. 1, 2015 (CN) 201510864355X

(51) Int. Cl. H04L 29/06; G06F 12/0868; H04L 29/08

(52) U.S. Cl. CPC H04L 67/42; H04L 67/2857; H04L 67/1097; G06F 12/0868; G06F 2212/621

(57) ABSTRACT

An embodiment of the present disclosure relates to the field of computers, and discloses a server, a method, and a system for providing service data. The server includes: a receiving device, configured to receive a data read request from a client; and a processing device, configured to inquire a local cache for data requested by the data read request, and execute one of the following: if the data is found, sending the data from the local cache to the client, and if the data is not found, inquiring a cluster cache for the data and sending the data to the client. A data access speed of the local cache is far greater than that of the cluster cache, and therefore a speed of responding to a data read request by a server can be dramatically increased.

### CROSS-REFERENCE TO RELATED APPLICATIONS

This application is a continuation of International Application No. PCT/CN2016/089515, filed on 10 Jul. 2016, which claims priority to Chinese Patent Application No. 201510864355.X, filed on Dec. 1, 2015, the entire contents of all which are hereby incorporated by reference.

### TECHNICAL FIELD

The present disclosure relates to the field of computers, and in particular, to a server, a method, and a system for providing service data.

### BACKGROUND

Currently, when a server receives a data service request from a client of a customer, the server majorly inquires a database stored in a magnetic disk on the server for corresponding data, and sends the found data to the client, so as to respond to the data service request. However, restrictions of a communications environment (such as network bandwidth, signal received strength, and signal interference) and a processing speed of a server lead to an excessively long time for responding to a data service request from a client by the server, thereby making it difficult to enable a customer that operates the client to have a good service experience.

How to improve the speed of responding to a data service request by a server has always been a technical problem to solve in this field.

### SUMMARY

An objective of some embodiments of the present disclosure is to provide a brand new data processing method for use in a server, capable of reducing time for responding to a data service request by the server.

Correspondingly, an embodiment of the present disclosure further provides a method for providing service data. The method includes: receiving a data read request from a client; and inquiring a local cache of a server for data requested by the data read request; sending, if the data is found in the local cache, the data from the local cache to the client, and inquiring, if the data is not found in the local cache, a cluster cache for the data and sending the data from the cluster cache to the client.

If the data is not found in the local cache, the data found in the cluster cache is updated to the local cache.

The data read request is an application update request.

If the data read request is an application update request, a latest version of each application in the cluster cache is updated to the local cache.

According to an embodiment of the present disclosure, there is provided with a non-transitory computer-readable storage medium storing executable instructions that, when executed by an electronic apparatus, cause the electronic apparatus to perform an above disclosed method.

According to an embodiment of the present disclosure, there is provided with an electronic apparatus. The electronic apparatus includes: at least one processor; and a memory communicably connected with the at least one processor for storing instructions executable by the at least one processor, wherein execution of the instructions by the at least one processor causes the at least one processor to perform an above disclosed method.

The technical solution provides a data update mechanism between a cluster cache of a server and a local cache of the server. With respect to each data read request, the server may first inquire a local cache of the server to determine whether there is data requested by the data read request. If there is the data requested by the data read request, the data may be directly sent to a client; and if there is not the data requested by the data read request, the cluster cache may be inquired for the data requested by the data read request and the data is sent to the client. Generally, a data access speed of the local cache (which response time generally is 1 ms) is far greater than that of the cluster cache (which response time generally is 10 ms), and therefore a speed of responding to a data read request by a server can be dramatically increased. In addition, a data update mechanism between the cluster cache and the local cache provided by an embodiment of the present disclosure can ensure that data requested by most data read requests from a client can be found in the local cache, reduce the probability that data requested by a data read request needs to be sent from a cluster cache to a client, and increase a speed of responding to most data read requests by the server.

The other features and advantages of some embodiments of the present disclosure are described in detail in the detailed description below.

### BRIEF DESCRIPTION OF THE DRAWINGS

The accompanying drawings are provided for facilitating understanding of some embodiments of the present disclosure, constitute a part of the specification, and are used to interpret the present disclosure together with the detailed description below, but are not intended to limit the present disclosure. In the accompanying drawings:

FIG. 1 is a schematic structural diagram of a data serving system according to an embodiment of the present disclosure;

FIG. 2 is a schematic diagram of a method for providing service data according to an embodiment of the present disclosure; and

FIG. 3 is a flow chart of a method for providing service data in a case in which a data read request is an application update request according to an embodiment of the present disclosure.

FIG. 4 illustrates a schematic hardware diagram of an electronic apparatus according to an embodiment of the present disclosure.

Description of Referential Numerals

| | | | |
|---|---|---|---|
| 100 | Client | 200 | Server |
| 210 | Receiving device | 220 | Processing device |
| 230 | Local cache | 240 | Cluster cache |
| 250 | Database | | |

### DETAILED DESCRIPTION

The present disclosure is described in detail through specific implementing manners of some embodiments in combination with the accompanying drawings. It should be understood that the specific implementing manners described herein are used to describe and interpret the present disclosure only, and are not intended to limit the present disclosure.

Two concepts involved in the following specification, “local cache” and “cluster cache”, are interpreted before presentation of the detail description of some embodiments of the present disclosure. The “local cache” indicates a dedicated cache of a server, generally it takes 1 ms for the local cache to respond, but a capacity of the local cache is fixed. A typical example of the “local cache” is EhCache, and the EhCache is a cache framework in progress of a pure Java and has features of being fast and highly capable. The “cluster cache” indicates that each serving node may contribute a part of cache in a case in which a plurality of serving nodes constructs a server cluster, and in this way the server cluster forms a cluster cache, and the cluster cache is constructed by caches contributed by each serving node. A response speed of the cluster cache is lower than that of the local cache, generally it takes 10 ms, but a capacity of the cluster cache thereof may be extended according to needs. For example, more serving nodes may be added or a greater capacity may be contributed by the serving nodes, to extend the cluster cache.

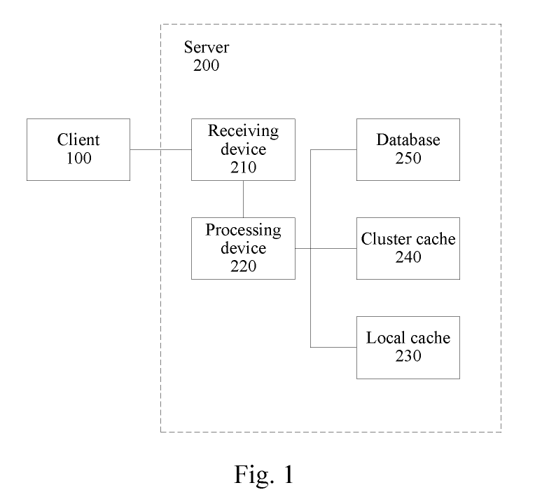

FIG. 1 is a schematic structural diagram of a data serving system according to an embodiment of the present disclosure. As shown in FIG. 1, an embodiment of the present disclosure provides a data serving system. The system includes a client 100 and a server 200 configured to provide service data. The server 200 includes a receiving device 210, a processing device 220, a local cache 230, a cluster cache 240, and a database 250. The database 250 stores all relevant service content data (including various types of data, such as user favorites, user comments, application versions, application packages, and other information about applications) that can be provided by the data serving system, and the database 250 may regularly (for example, for each 5 minutes) update the service content data to the cluster cache 240. The local cache 230 has an invalidation policy, i.e. data in the local cache 230 may automatically become invalid after a predetermined period of time (for example, 5 minutes). The receiving device 210 is configured to receive a data read request from the client 100. The processing device 220 is configured to inquire the local cache 230 for data requested by the data read request, and execute one of the following: if the data is found, sending the data from the local cache 230 to the client 100, and if the data is not found, inquiring the cluster cache 240 for the data and sending the data to the client 100. By means of this, by first inquiring the local cache 230 for the data and sending the data to the client 100 if the data is found, a speed of responding to the data read request by the server 200 can be increased.

It should be noted that, the server 200 appearing in the above description is enabled to include the cluster cache, majorly in consideration of the fact that some caches of the cluster cache are contributed by the server 200. The cluster cache may actually used as an independent component outside the server 200. The description is provided by directly including the cluster cache in the server 200 for the purpose of simplifying description herein.

The processing device 220 is further configured to, if the data is not found in the local cache 230, update the data found in the cluster cache 240 to the local cache 230. By means of this, the probability of finding, from the local cache 230, data requested by a data read request can be increased, since the server 200 may, in most cases, receive identical requests from a plurality of clients 100 at the same time. For example, during Christmas, users may centrally access a webpage in a subject of Christmas. In this case, although a user that first accesses the webpage may probably need to acquire data from a cluster cache and a response speed of the server 200 is mediocre, the users that subsequently access the webpage may all find data to be accessed in the local cache 230, thereby increasing the speed of responding to subsequent user accesses.

The data read request may be an application update request. Processing with respect to the application update request is substantially consistent with the processing with respect to the general data read request described above, that is, first the local cache 230 is inquired for a latest version of an application at which the application update request aims, moreover, the latest version of the application is sent to the client 100 if the latest version of the application is found; if the latest version of the application is not found in the local cache 230, the cluster cache 240 is inquired for the latest version of the application and the latest version of the application is sent to the client 100. The difference lies in that: the processing device may update a latest version of each application in the cluster cache 240 to the local cache 230, that is, the latest version of each application in the cluster cache 240 is updated to the local cache 230 regardless of whether the latest version of the application is found in the local cache 230. In this way, in consideration of a fact that applications requested to be updated at each client 100 may be different, after the latest version of each application is updated to the local cache 230, the processing device may directly find, from the local cache 230, the latest version of the application at which the application update request aims, and send the latest version to the client 100 for a subsequent application update request of another client 100, thereby increasing the speed of responding to the application update request by the another client 100.

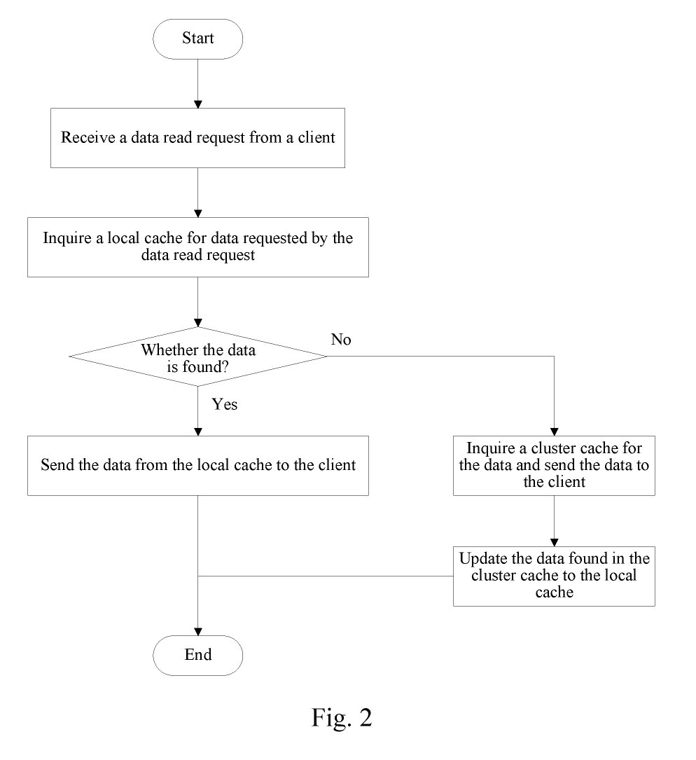

FIG. 2 is a schematic diagram of a method for providing service data according to an embodiment of the present disclosure. Correspondingly, as shown in FIG. 2, an embodiment of the present disclosure further provides a method for providing service data, the method includes: receiving a data read request from a client 100; and inquiring a local cache 230 for data requested by the data read request, and executing one of the following: if the data is found, sending the data from the local cache 230 to the client 100, and if the data is not found, inquiring a cluster cache 240 for the data and sending the data to the client 100. If the data is not found in the local cache 230, the data found in the cluster cache 240 is updated to the local cache 230.

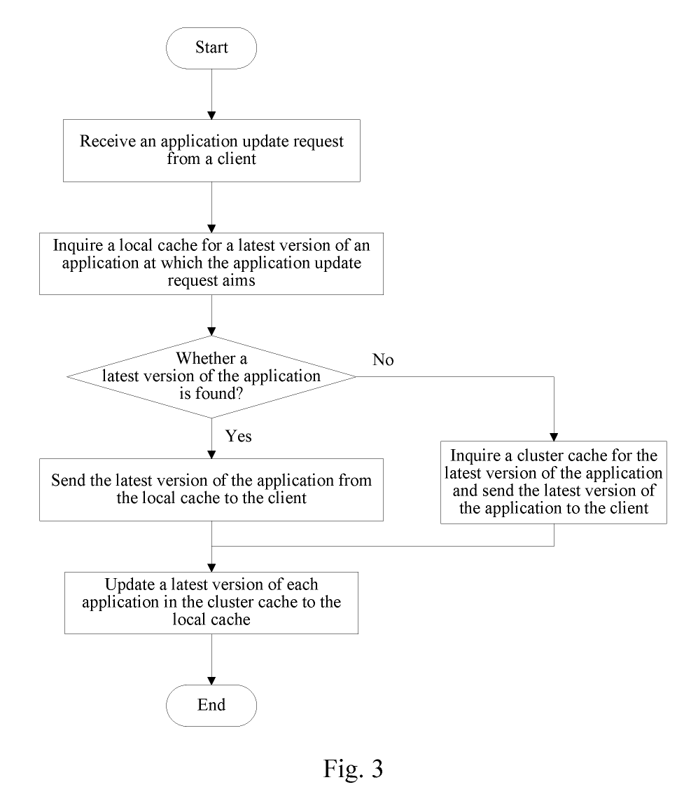

The data read request may be an application update request. FIG. 3 is a flow chart of a method for providing service data in a case in which a data read request is an application update request according to an embodiment of the present disclosure. As shown in FIG. 3, if the data read request is an application update request, the method further includes: updating a latest version of each application in the cluster cache 240 to the local cache 230.

Through a solution of an embodiment of the present disclosure, by first inquiring the local cache 230 for data requested by a data read request, the data can be directly sent to the client 100 if the data can be found, because a response speed of the local cache 230 is relatively large, a speed of responding to the data read request by the server 200 can also be increased. Even if the data cannot be found in the local cache 230, the data can still be found in the cluster cache 240 and the data is sent to the client 100. The data is simultaneously updated to the local cache 230, so as to ensure that data requested by an identical data read request by another client 100 can be found in the local cache 230, thereby increasing the speed of responding to the another client by the server 200. This embodiment can ensure, through flexible coordination of data between the cluster cache 240 and the local cache 230, most data to be directly read by the local cache 230, thereby increasing the speed of responding to a data read request from the client 100 by the server 200.

According to an embodiment of the present disclosure, there is provided with a non-transitory computer-readable storage medium storing executable instructions that, when executed by an electronic device with a touch-sensitive display, cause the electronic device to perform any of the above disclosed methods.4 shows one processor PRS as an example.

The electronic apparatus can further include an input apparatus IPA and an output apparatus OPA.

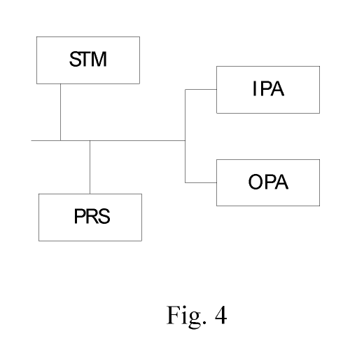

The one or more processors PRS, storage medium STM and output apparatus OPA may be connected by a bus or other means. FIG. 4 shows a bus as an example for connection.

Storage medium STM is a non-transitory computer-readable medium for storing a non-transitory software program, a non-transitory computer-readable program and module, for example the program instructions/module for an above described method (such as, the processing device 220 shown in FIG. 1). The processor PRS can operate the various functions and data processing of a server to perform a method described in the above embodiments by executing non-transitory software programs, instructions and modules stored in the storage medium STM.

The storage medium STM can include a program storage area and a data storage area. Among them, the program storage area may store operation system, application programs of at least one function; the data storage area may store generated data during operation of the electronic apparatus for performing the method described in the above embodiments. In addition, the storage medium STM may include a high speed random access memory, and a non-transitory storage medium, for example a magnetic storage device (e.g., hard disk, floppy disk, and magnetic strip), a flash memory device (e.g., card, stick, key drive) or other non-transitory solid state storage device. In some embodiments, the storage medium STM may include a storage medium that is remote to the processor PRS. The remote storage medium may be connected to the electronic apparatus for performing any of the above methods by a network. The examples of such as network include but not limited to Internet, enterprise intranet, local area network, mobile telecommunication network and a combination thereof.

The input apparatus IPA can receive input number or byte information, and can generate input key information relating to user setting and functional control of the electronic apparatus for performing the method described in the above embodiments. The output apparatus OPA may include a display device such as a display screen.

The one or more modules stored in the storage medium STM that, when executed by the one or more processors PRS, can perform any of the above described methods.

The above products can perform any of the above described methods, and have corresponding functional modules and effects. Details that are not disclosed in this embodiment can be understood by reference to the above method embodiments of the present disclosure.

An electronic apparatus of the present disclosure can exist in a varied form and includes but not limited to:
(1) A mobile communication device which is capable of performing mobile communication function and having a main purpose for audio or data communication. Such a mobile communication device includes: a smart phone, a multimedia phone, a functional mobile phone and a low-end mobile phone etc.
(2) A super-mobile personal computer which belongs to the field of a personal computer and has calculation and processing functions, and in general can access to a mobile network. Such a terminal device includes: a PDA, a MID and a UMPC etc.
(3) A portable entertainment device which is capable of displaying and playing multimedia content. Such a device includes: an audio player, a video player (e.g. iPod), a handheld game console, an electronic book, a smart toy and a portable automotive navigation device.
(4) A server which can provide calculation service and can include a processor, a hard disk, a memory, a system bus etc. Such a server is similar to a general computer in terms of a computer structure, but is necessary to provide reliable service, which therefore requires a higher standard in certain aspects such as data processing, stability, reliability, security and compatibility and manageability etc.
(5) Other electronic apparatus that is capable of data exchange.

The above described apparatus embodiments are for illustration purpose only, in which units that are described above as separate elements may be physically separate or not separate and units that are described above as display elements may be or may not be a physical unit, i.e. in a same location or in various distributed network units. The skilled person in this field can understand that it is possible to select some or all of the units or modules to achieve the purpose of the embodiment.

According to the above description, the skilled person in this field can understand that various embodiments can be implemented by software over a general hardware platform or by hardware. Accordingly, the above technical solution or what is contributed to the prior art may be implemented in the form of software product. The computer software product may be stored in a computer-readable storage medium, for example random access memory (RAM), read only memory (ROM), compact disk (CD), digital versatile disk (DVD) etc. which includes instructions for causing a computing device (e.g. a personal computer, a server or a network device etc.) to perform a method of some or all parts of any one of the above described embodiments.

The previous embodiments are provided to enable any person skilled in the art to practice the various embodiments of the present disclosure described herein but not to limit these aspects. Though the present disclosure is described by reference to the previous embodiments, various modifications and equivalent features will be readily apparent to those skilled in the art without departing from the spirit and scope of the present disclosure, and the generic principles defined herein may be applied to other aspects or with equivalent features. Thus, the claims are not intended to be limited to the aspects and features shown herein, but are to be accorded the full scope consistent with the language of the claims.

Preferably implementing manners of some embodiments of the present disclosure are described in detail in combination with the accompanying drawings. However, the present disclosure is not limited to the specific details of the implementing manners. Various simple transformations can be made to the technical solutions of the present disclosure, and these simple transformations all fall within the protection scope of the present disclosure.

In addition, it should be noted that, the various specific technical features described in the detailed description can be combined in any suitable manners in the case of no contradiction. To avoid unnecessary repetition, the respective possible combination manners are not described in the present disclosure.

In addition, any of the various implementing manners of the present disclosure may also be combined as long as not departing from the concept of the present disclosure, and should be similarly fall within the disclosure of the present disclosure.

What is claimed is:

1. A method performed by a server for providing service data, comprising:
receiving a data read request from a client;
inquiring a local cache of the server for data requested by the data read request;
sending, if the data is found in the local cache, the data from the local cache to the client; and
inquiring, if the data is not found in the local cache, a cluster cache for the data and sending the data from the cluster cache to the client.

2. The method according to claim 1, further comprising: if the data is not found in the local cache, updating the data found in the cluster cache to the local cache.

3. The method according to claim 1, wherein the data read request is an application update request.

4. The method according to claim 3, further comprising: if the data read request is an application update request, updating a latest version of each application in the cluster cache to the local cache.

5. A non-transitory computer-readable storage medium storing executable instructions that, when executed by an electronic apparatus, cause the electronic apparatus to:
receive a data read request from a client;
inquire a local cache of the server for data requested by a data read request;
send, if the data is found in the local cache, the data from the local cache to the client; and
inquire, if the data is not found in the local cache, a cluster cache for the data and sending the data from the cluster cache to the client.

6. The storage medium according to claim 5, further comprising instructions to update, if the data is not found in the local cache, the data found in the cluster cache to the local cache.

7. The storage medium according to claim 5, wherein the data read request is an application update request.

8. The storage medium according to claim 7, further comprising instructions to update, if the data read request is an application update request, a latest version of each application in the cluster cache to the local cache.

9. An electronic apparatus, comprising:
at least one processor; and
a memory communicably connected with the at least one processor for storing instructions executable by the at least one processor;
wherein execution of the instructions by the at least one processor causes the at least one processor to:
inquire a local cache of the server for data requested by a data read request;
send, if the data is found in the local cache, the data from the local cache to the client; and
inquire, if the data is not found in the local cache, a cluster cache for the data and sending the data from the cluster cache to the client.

10. The electronic apparatus according to claim 9, the memory further comprises instructions to update, if the data is not found in the local cache, the data found in the cluster cache to the local cache.

11. The electronic apparatus according to claim 9, wherein the data read request is an application update request.

12. The electronic apparatus according to claim 11, the memory further comprises instructions to update, if the data read request is an application update request, a latest version of each application in the cluster cache to the local cache.
